(19) United States
(12) Patent Application Publication
(10) Pub. No.: US 2026/0264980 A1
(43) Pub. Date: Sep. 10, 2026

(54) COMPACTOR WITH IMPROVED CLOSURE SYSTEM

(71) Applicant: Compaction Technologies, Inc., Eagan, MN (US)

(72) Inventors: Peyton Trodahl Bolstad, Eagan, MN (US); Mason Robert Beissel, Hastings, MN (US); Kyle Rodger Liebetrau, Cottage Grove, MN (US)

(21) Appl. No.: 19/556,727

(22) Filed: Mar. 4, 2026

Related U.S. Application Data
(60) Provisional application No. 63/768,035, filed on Mar. 6, 2025.

(51) Int. Cl. B65F 1/14

(52) U.S. Cl. CPC B65F 1/1405

(57) ABSTRACT

A compaction machine may include an enclosure defining an opening for receiving trash. The machine may also include a compaction system having an actuation portion and a ram. The compaction system may be arranged within the enclosure and may also be configured for compacting the trash within the enclosure by performing a compaction cycle. The cycle may include moving the ram from a retracted position to an expanded position. The machine may also include a closure mechanism operable between an open position where the opening is generally unobstructed and a closed position where the closure mechanism closes off the opening. The operability of the closure mechanism between the open position and the closed position may be mechanically dependent on motion of the compaction system over at least a portion of the compaction cycle. A method of opening and closing a compaction machine is also described.

### PRIORITY APPLICATIONS

This application claims the benefit of priority to U.S. Provisional Patent Application Serial No. 63/768,035, filed Mar. 6, 2025, the content of which is incorporated herein by reference in its entirety.

### TECHNOLOGICAL FIELD

The present application relates to compaction. More particularly, the present application relates to compaction of trash such as garbage and/or paper towels. Still more particularly, the present application relates to compactors suitable for use in public venues such as front of house compactors and/or compactors in bathrooms.

### BACKGROUND

The background description provided herein is for the purpose of generally presenting the context of the disclosure. Work of the presently named inventor, to the extent it is described in this background section, as well as aspects of the description that may not otherwise qualify as prior art at the time of filing, are neither expressly nor impliedly admitted as prior art against the present disclosure.

Trash compactors can include a variety of moving parts. For example, they may include a compression head that may function to compact the trash. In addition, a bin may be provided to receive the trash. The bin may sometimes be movable between a trash receiving position and a compaction position. Still further, on the housing of the trash compactor, access doors may be provided. The access doors may allow for the trash compactor to receive trash at selected times. Other access doors may be provided to allow access within the machine for maintenance or other services. Many of these moving parts may include dedicated actuators or other equipment to allow for the movement of the moving part. As with most dynamic moving equipment, moving parts may be subject to breakage and/or failure.

### SUMMARY

In one or more examples, a compaction machine may include an enclosure defining an opening for receiving trash. The machine may also include a compaction system having an actuation portion and a ram. The compaction system may be arranged within the enclosure and may also be configured for compacting the trash within the enclosure by performing a compaction cycle. The cycle may include moving the ram from a retracted position to an expanded position. The machine may also include a closure mechanism operable between an open position where the opening is generally unobstructed and a closed position where the closure mechanism closes off the opening. The operability of the closure mechanism between the open position and the closed position may be mechanically dependent on motion of the compaction system over at least a portion of the compaction cycle.

In one or more other examples, a method of opening and closing a compaction machine may include activating a compaction system within an enclosure and driving a ram toward and into a receptable holding trash to compact the trash. The method may also include allowing a closure mechanism to close off an opening in the enclosure under the force of gravity at a rate controlled by motion of a portion of the compaction system during the driving.

While multiple embodiments are disclosed, still other embodiments of the present disclosure will become apparent to those skilled in the art from the following detailed description, which shows and describes illustrative embodiments of the invention. As will be realized, the various embodiments of the present disclosure are capable of modifications in various obvious aspects, all without departing from the spirit and scope of the present disclosure. Accordingly, the drawings and detailed description are to be regarded as illustrative in nature and not restrictive.

### BRIEF DESCRIPTION OF THE DRAWINGS

While the specification concludes with claims particularly pointing out and distinctly claiming the subject matter that is regarded as forming the various embodiments of the present disclosure, it is believed that the invention will be better understood from the following description taken in conjunction with the accompanying Figures, in which:

FIG. 1 is a perspective view of a compactor, according to one or more examples.

FIG. 2 is a side view of the compactor of FIG. 1.

FIG. 3A is a top, front, side perspective view of a compaction mechanism of the compactor of FIG. 1, according to one or more examples.

FIG. 3B is a bottom, front, side perspective view of the compaction mechanism of FIG. 3A.

FIG. 4A is a top, rear, side perspective view of a chute and closure mechanism of the compactor of FIG. 1, according to one or more examples.

FIG. 4B is a top, rear, side perspective view of the chute of FIG. 4A.

FIG. 4C is an exploded view of the chute and closure mechanism of FIG. 4A.

FIG. 5 is a diagram depicting a method of operation of a compactor, according to one or more examples.

### DETAILED DESCRIPTION

The present application, in one or more examples, may relate to a streamlined trash compactor. For example, the present application may include a trash compactor that has a reduced number of moving parts and or actuators. In particular, the present application may include a trash compactor with one or more moving parts and an actuator that is capable of moving the several parts. Still more particularly, the present application may include a compaction head and an actuator for the compaction head where motion of the compaction head also controls or allows for closure of an access door thereby closing off access within the machine when compaction is occurring and using a single actuator for this purpose. This design may be advantageous by minimizing the number of actuators and, as such, the number of parts that may be subject to breakage or failure.

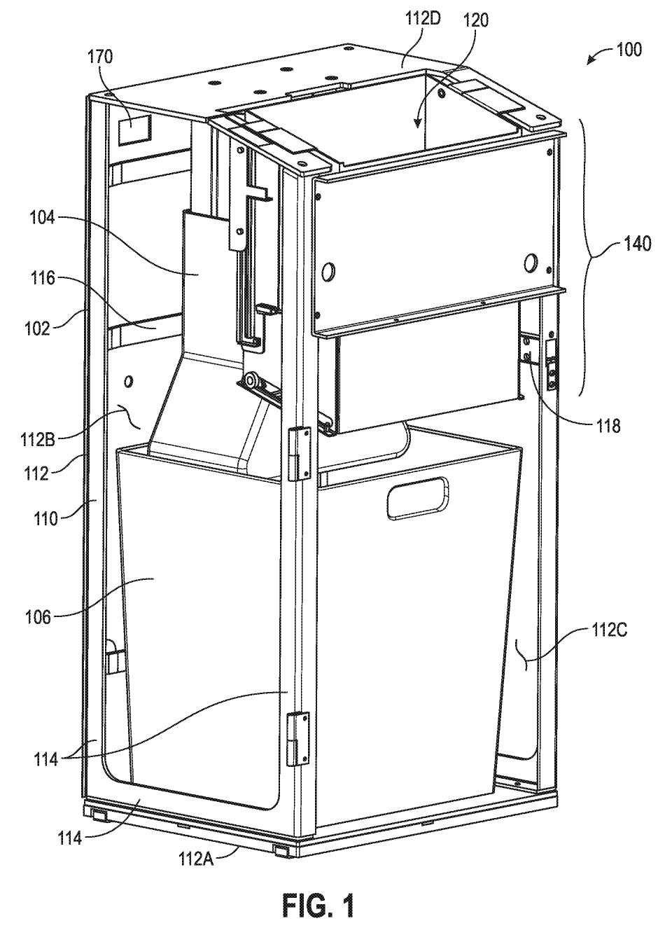

Turning now to FIG. 1, one example of a compaction machine 100 is shown. The compaction machine 100 may be configured as a receptacle to receive trash as well as a compactor to compact the trash. In one or more examples the compaction machine 100 may be particularly suited for receiving paper towels such as in a bathroom or other location where paper towels are being discarded. The compaction machine 100 may include an enclosure 102, a compaction system 104, and a collection system 106.

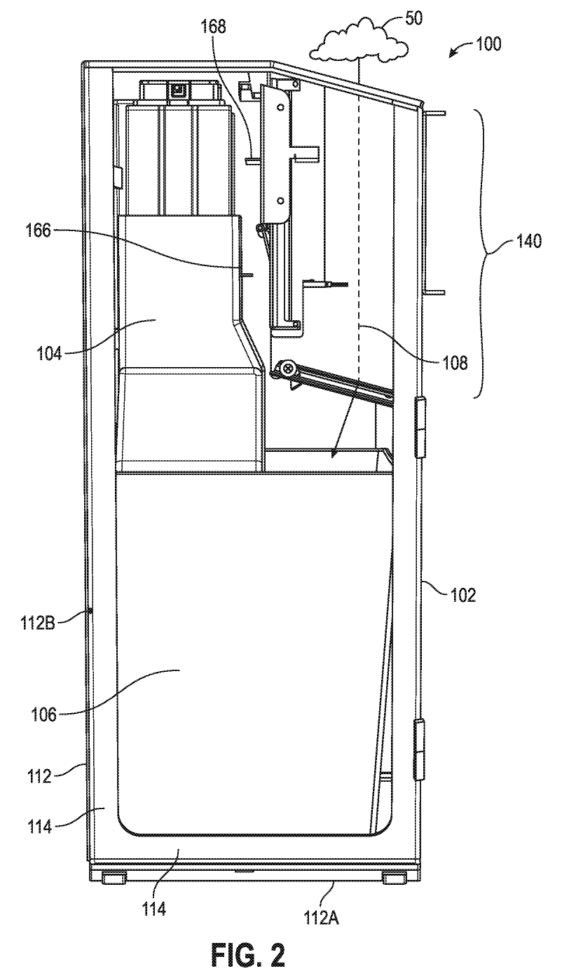

With continued reference to FIG. 1 and to FIG. 2, the enclosure 102 may be configured to enclose the collection system 106 and the compaction system 104 and may include one or more access pathways 108 for receiving trash 50 and/or for providing other access within the machine 100. In one or more examples, the enclosure 102 may be configured to form a force-resisting framework to resist forces of the compaction system 104 and, as such, portions of the enclosure 102 may also be considered part of the compaction system 104. In one or more examples, the enclosure 102 may include a frame 110 and a housing or shell 112 attached to the frame 110. In other examples, a self-supporting housing or shell such as a fiberglass housing or metal housing may be provided. Still other approaches to formation of an enclosure may be provided. As shown, the enclosure may include a bottom, a top, a front, a back, a left side, and a right side.

In the present example, and with reference to FIGS. 1 and 2, the enclosure 102 may include a frame 110 in the form of a pair of generally u-shaped sides 114. The u-shaped sides 114 may include frame members in the form of angles such as steel or aluminum angles. In other examples, the frame members may be in the form of tubes, pipes, bars, or other cross-sectional shapes. The frame 110 may also include a plurality of straps 116 extending across the back of the enclosure 102 from a rear vertical leg of one of the u-shaped side 114 to a corresponding vertical leg of the other u-shaped side 114. The plurality of straps 116 may be spaced apart along the height of the compaction machine 100. One or more additional straps 118 may be arranged to extend along the sides of the frame 110 from a rear vertical leg of one of the u-shaped sides 114 to a front leg of the same u-shaped side 114.

With continued reference to FIGS. 1 and 2, housing plates or panels 112 may also be provided and attached to the frame 110. For example, a bottom housing panel 112A may extend between the u-shaped sides 114 along the bottom of the machine 100. A back housing panel 112B as well as two opposing side housing panels 112C may also be provided on a respective back and respective sides of the machine 100. Still further, a top housing panel 112D may also be provided on a top of the machine 100 and a front housing panel (not shown) may also be provided. The bottom, back, side panel, and front panels 112 may be generally solid panels extending to the extents of the frame on their respective side of the machine and might not have any openings, doors, or other access panels. In one or more examples, one or more of these listed panels may have an opening such as an opening for an electrical cord or may include an access panel such as a pivoting door type panel or a panel secured with screws or other fastening systems. Still other panel interruptions may be provided. The top housing panel 112D may define an opening 120 for receiving trash, which may give way to a chute 140 described in further detail below. Still further, the top and bottom housing panels 112A/112D may be relatively robust panels that may be substantially thicker than the back, front, and side housing panels 112B/C. This may be for purposes of spanning the distance from one u-shaped side 114 to another under the loading provided by the compaction system 104. That is, as the compaction system 104 compresses the trash, it may press upward on the top housing panel 112D and downward on the bottom housing panel 112A. These panels may be tied together by the u-shaped sides 114 of the frame 110 to maintain the position and shape of the machine 100 during compaction.

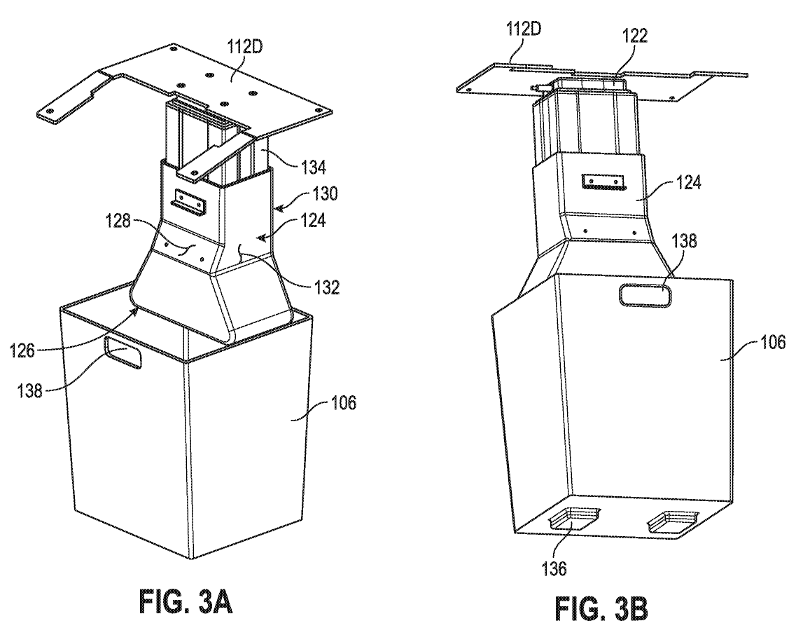

Turning now to FIGS. 3A-3B, the compaction system 104 may be configured for compacting trash within the machine 100. The compaction system 104 may include an actuation portion 122 and a ram 124. The actuation portion 122 may be secured to the enclosure 102 of the machine and/or to the top housing panel 112D. The actuation portion 122 may be arranged generally in a back half of the machine 100 near the top of the machine 100. The actuation portion 122 may include one or more of a screw drive, a gear drive such as a rack/pinion drive, a hydraulic cylinder, or another actuator configured for forcibly driving the ram 124. In one or more examples, the actuation portion 122 may include one or more telescoping sections and may also include one or more drive mechanisms such as a scissor drive or other mechanism for causing the telescoping sections to extend. That is, for example, the actuator (e.g., hydraulic cylinder) may be coupled to a scissor system that extends as the actuator drives it to create additional extension based on more limited movement of the actuator.

On a bottom end of the actuation portion 122 and, more particularly, on the end of the drive mechanism opposite the actuator, a ram 124 may be provided for contacting and compacting the trash. As shown, the ram 124 may include a relatively broad bottom plate 126 having a surface sized to fit within the trash receptacle, but large enough to engage a surface area similar to the bottom of the receptacle. The ram 124 may also include upward extending front 128, back 130, and side 132 walls that may telescopingly engage a housing 134 on the actuation portion 122 to form the mentioned telescoping sections. This may enclose the internal mechanisms of the compaction system 104 and may help prevent debris and other trash from interfering with these internal mechanisms. As shown in FIGS. 3A and 3B, the front side wall 128 may be angled up and back from a front edge of the bottom plate 126. This may allow the front edge of the bottom plate 126 to be arranged forward of the front surface of the actuation portion 122 and the angle of the front side wall 128 may help to avoid having trash or debris hang up on the ram 124 above the bottom plate 126. That is, falling trash encountering the front surface 128 of the ram 124 may be guided forward and down around the front edge of the bottom plate 126 of the ram 124.

The actuation portion 122 and the ram 124 may each be located and sized to occupy an upper rear portion or quadrant of the machine 100 when in the retracted position so as to allow trash to fall into the machine 100 and below the compaction mechanism 104. In the extended position, the actuation portion 122 and the ram 124 may occupy generally a back half or back portion of the machine 100 and extend generally the full height of the machine 100.

With continued reference to FIGS. 3A and 3B, the collection system 106 may be configured to receive trash through the opening 120 in the enclosure 102 and to have the trash compacted within it. In one or more examples, the collection system 106 may include a receptacle arranged in the bottom of the machine 100. The receptacle may be placed or arranged such that it rests on an inside surface of the bottom housing panel 112A. In one or more examples, the receptacle may include front, back, side panels and a bottom panel, but an open top. As shown, the bottom panel may include raised feet 136 for holding the bottom panel off of the bottom of the machine. In one or more examples, the receptacle may be sized to generally occupy the full area in the bottom of the machine. The front, back, and/or side panels of the receptacle may also be tapered and/or may include a draft angle to create a receptacle with a top opening having an area slightly larger than the area of the bottom of the receptacle. While not shown, in some examples, the front panel of the receptacle may have a steeper draft angle so as to direct trash toward a back half of the receptacle such that it is more likely to be arranged below the ram 124 of the compaction system 104. In some examples, the receptacle may, thus, be non-symmetrical about a plane parallel to the front/back of the machine 100 and centered (e.g., front to back) on the receptacle. In one or more examples, and while not shown, the front panel of the receptacle may have a rearward and sloped step at some point along its height so that trash may be urged rearwardly and then fall into a rearward pocket for compaction by the ram 124. Still other receptacle geometries may be provided such, when viewed from above, rectangular with rounded corners, round, oval, and other shapes. In one or more examples, the front, back, and/or side panels may include openings 138 to provide a handle to grasp and/or lift the receptacle.

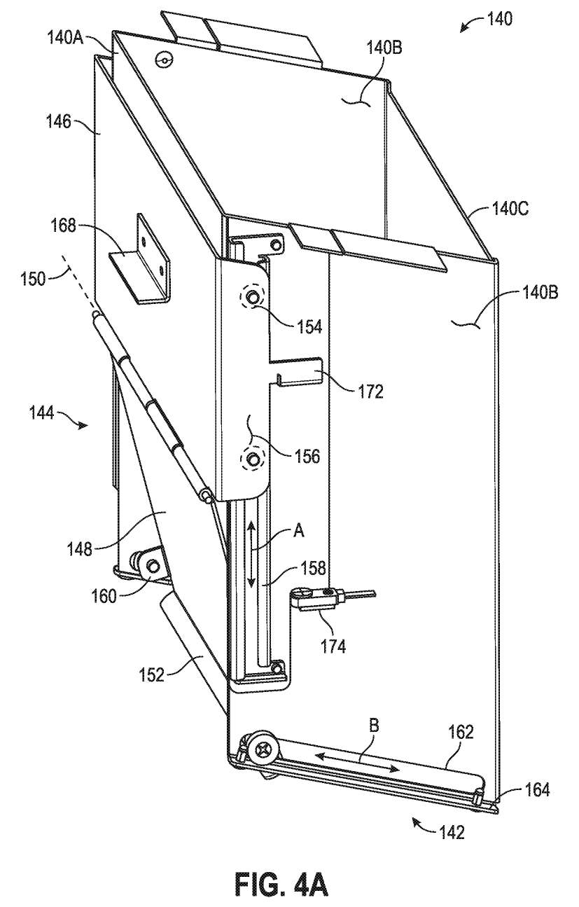

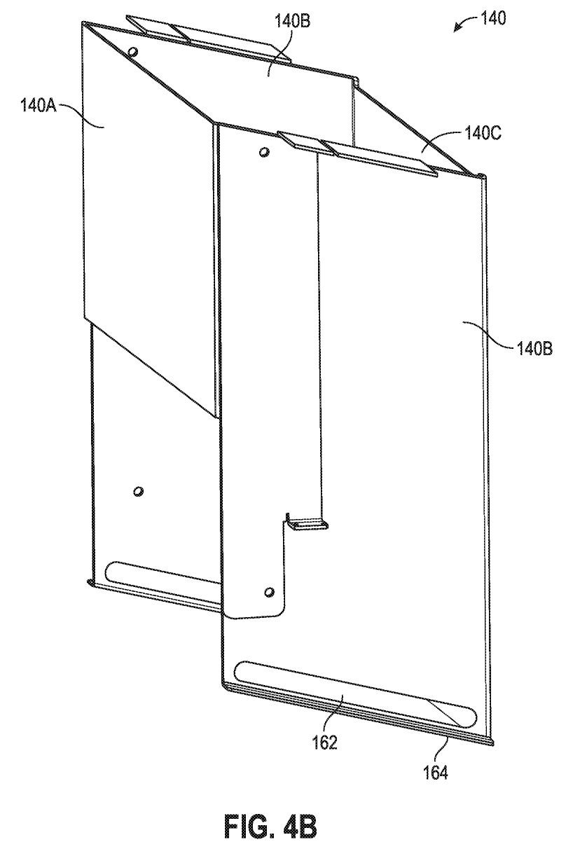

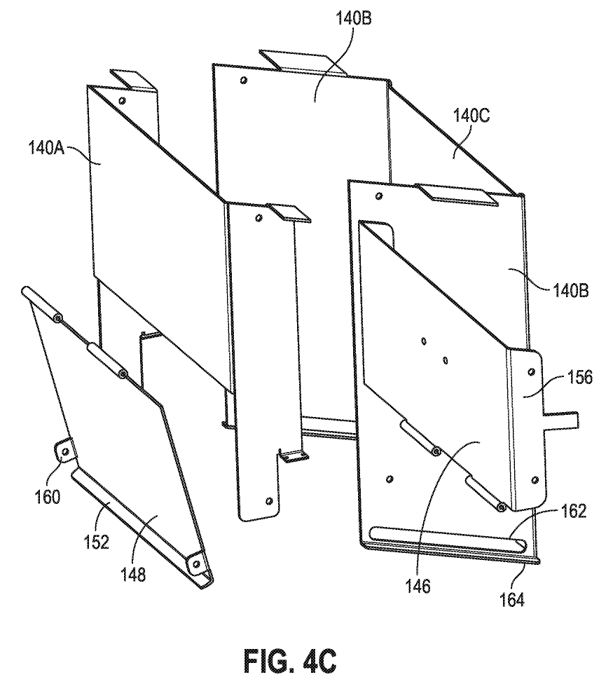

As mentioned above, the opening 120 in the top housing panel 112D may give way to a chute. That is, the enclosure 102 may define a portion of a trash receiving pathway 108 where the opening 120 in the top housing panel 112D gives way to a chute 140 extending from the top housing panel 112D and into the compaction machine 100. The chute 140 may be lined with chute panels to guide the trash along the trash receiving pathway. In one or more examples as shown in more detail in FIGS. 4A-4C, the chute may include a back chute panel 140A, two side chute panels 140B, and a front chute panel 140C. In one or more examples, the front chute panel 140C may be formed by a plate or panel or may be formed by the back side of the front housing panel of the machine 100. The back chute panel 140A may be arranged at or near the mid-depth of the machine to provide room behind the back chute panel 140A for portions of the compaction system 104. In some examples, the back chute panel 140A may be generally rectangular, the front chute panel 140C may be generally rectangular, and the side chute panels 140B may have a parallelogram or rhombus shape to create a sloped top of the chute 140 and a sloped bottom of the chute 140. That is, when viewed from the side as in FIGS. 4A-4C, the chute 140 may be defined by a top end that slopes toward the front of the machine and a sloping bottom end that also slopes toward the front of the machine 100. The front and back chute panels 140A/C may be generally parallel to one another and the sloping top and bottom of the chute may also be generally parallel to one another.

It is to be appreciated that while the chute 140 has been said to extend from the top housing panel 112D and into the compaction machine 100, the chute 140 may also extend from both the top housing panel and the front housing panel or from both the top housing panel and a side housing panel or even the top housing panel and a back housing panel depending on the machine configuration. In one or more examples, the chute may extend from the front, the side, or the back housing panel and may not extend from the top housing panel. In any of these cases, and as shown in the present example, the chute 140 may extend into the machine 100 and may have a generally open bottom 142 to allow trash to fall into the receptacle or other aspect of the collection system 106.

While the bottom 142 of the chute 140 may be open, the open bottom 142 may be closeable such that access within the machine 100 may be prevented during compaction cycles, for example. As shown in FIGS. 4A-4C, the chute 140 may include a closure mechanism 144, which may be configured for closing off access to areas within the machine 100 beyond the bottom of the chute 140. In one or more examples, the closure mechanism 144 may be in the form of a sliding closure panel or panels. In other examples, the closure mechanism may be in the form of a pivoting door, a slatted flexible closure device, a flexible membrane, or another mechanism for closing off the opening 142 at the bottom of the chute 140. It is noted that during compaction cycles, when the closure mechanism 144 is closed, trash may still be received and accumulated within the chute 140, but outside the closure mechanism 144 such that the machine 100 is still useable for disposal of trash during the compaction cycle. That is, during a compaction cycle, the chute 140 and closure mechanism 144 may form a hopper to accumulate and hold trash while the compaction cycle is completed. Once the compaction cycle is complete, the closure mechanism 144 may be opened to allow the trash accumulated in the chute 140 to fall into the receptacle and to allow further trash to be added and pass through the chute 140 and into the receptacle.

In the present example, a two-panel closure mechanism 144 may be provided. As shown, the back chute panel 140A may extend only partially along the height of the chute 140. The closure mechanism 144 may include a first closure panel 146 that may be generally vertically arranged and configured to articulate up and down in a plane adjacent to the back chute panel 140A as shown by the back and forth arrow A of FIG. 4A. This first closure panel 146 may cooperate with the back chute panel 140A to selectively close off the back of the chute 140. A second closure panel 148 may pivotably depend from a bottom edge of the first closure panel 146. That is, a pivoting connection between the first closure panel 146 and the second closure panel 148 may define a generally horizontal pivot axis 150 extending along a bottom edge of the first closure panel 146 and a rear edge of the second closure panel 148. The pivot axis 150 may translate up and down along with the first closure panel 146. The rear edge of the second closure panel 148 may be pivotally coupled to the bottom edge of the first closure panel at the pivoting connection and the panel 148 may extend away from the rear edge to a front/lower edge that is generally parallel to the rear edge. The front/lower edge may extend side-to-side across the chute 140 and may include a turned-down leg 152 extending fully or partially along the front/lower edge. The front/lower edge of the second closure panel 148 may be pivotally coupled to the side chute panels 140B at rollers, slides, or other translation devices. As such, the pivoting coupling of the front/lower edge of the second closure panel to the side chute panels 140B may define a pivoting and translating axis where the axis extends generally parallel to and along the front/lower edge of the second closure panel and is translatable in a direction generally perpendicular to the axis and along the bottom edge of the side chute panels 140B. Where the bottom edge of the side chute panels 140B is sloped, the axis may be articulable along a slope, as shown by the back and forth arrow B in FIG. 4A.

As may be appreciated from the above description and the drawings, as the first closure panel 146 articulates downward, the rear edge of the second closure panel 148 may also articulate downward while the front/lower edge of the second closure panel 148 articulates across the bottom of the chute 140. The first closure panel 146 may be sized such that when the first closure panel 146 is in its lower most position, it fully or substantially fully closes off the remaining portion of the back side of the chute 140 that is not otherwise closed off by the back chute panel 140A. That is, the back chute panel 140A and the first closure panel 146 extend substantially the full length of the back edge of the side chute panels 140B. Similarly, the second closure panel 148 may be sized such that, when the first closure panel 146 is in its lower most position, the second closure panel 148 fully or substantially fully closes off the bottom of the chute 140. That is, the front/lower edge of the second closure panel 148 is arranged along the front and at the bottom of the chute 140 and the rear edge is arranged along the back and at the bottom of the chute 140, where the back and front of the chute are defined by the respective back and front chute panels 140A/C and the bottom of the chute 140 is defined by the bottom edge of the side chute panels 140B.

As mentioned, the first closure panel 146 may be configured to articulate up and down in a plane adjacent to the back chute panel 140A. This articulation may be provided and/or guided by a sliding or rolling feature 154 arranged along a back edge of the side chute panels 140B. That is, a shown in FIG. 4A, the first closure panel 146 may include forward extending flaps 156 extending vertically along each side of the first closure panel 146 and along an outside surface of the side chute panels 140B. A vertically extending track 158 may be arranged on the outside surface of the side chute panels 140B within the forward extending flaps 156. The flaps 156 may include rollers, slides, pins, or other mechanism 154 on an inside surface thereof that ride in and/or are guided by the vertically extending track 158.

As also mentioned, the front/lower edge of the second closure panel 148 may be pivotally coupled to the side chute panels 140B at rollers, slides or other translation devices. As shown in FIG. 4A, ears 160 may extend downward from side edges of the second closure panel 148 near the front/lower edge thereof. Pins, axles, or other pivot axis defining elements may extend from the ears 160 through a slot 162 in the side chute panels 140B. Rollers, slides, or other translation mechanism may be provided outside the side chute panels 140B. Still further, a ledge 164 may be provided along the bottom edge of the side chute panels 140B for guiding the rollers, slides, or other translation mechanism along the bottom edge of the side chute panels 140B.

In one or more examples, the closure mechanism 144 including the first and second closure panels 146/148 may be generally free to move without any biasing mechanism or brake. Due to the vertical arrangement and freedom of movement of the first closure panel 146 and the sloped arrangement and freedom of movement of the second closure panel 148, when the machine is an upright position as shown in FIG. 1, the force of gravity may cause the closure mechanism 144 to be arranged in a close position. In the closed position, the second closure panel 148 may extend across a bottom of the chute 140 and the first closure panel 146 may extend along the back of the chute 140 below the back chute panel 140A. Accordingly, without more, the closure mechanism may be arranged in a closed position.

For purposes of opening the closure mechanism, and as shown in FIG. 2, a carrying feature 166 may be provided on the compaction system 104. The carrying feature 166 may be configured to open the closure mechanism 144 upon return or retraction of a portion of the compaction system such as, for example, the ram 124. As shown, the carrying feature166 may include an angle, tab, hook, or ledge extending forward from a front face of the ram or other articulating feature of the compaction system 104. In one or more examples, the carrying feature 166 may be arranged on the front wall 128 that extends upward from the bottom plate 126 of the ram 124. A corresponding catch 168 such as an angle, tab, loop, or overhang may be provided on a rear face of the first closure panel 146. The catch 168 may extend rearwardly from the first closure panel 146 such that it overlaps with the carrying feature 166 when viewed from above. Accordingly, as the ram 124 or other articulating feature of the compaction system 104 returns or retracts, the carrying feature 166 may engage the catch 168 on the first closure panel 146 and lift the closure panel 146 from its closed position to its open position. The second closure panel 148, being pivotably coupled to the first closure panel 146, may also move from its closed position to its open position. While the carrying feature 166 and catch 168 have been described as an angle, tab, hook/loop, and/or ledge/overhang, other types of engagement feature may be provided. For example, a magnetic engagement, a frictional engagement, or other engagement may be provided.

Regardless of the nature of the carrying feature 166 and the catch 168, as may be appreciated, the carrying feature 166 and corresponding catch 168 may provide for the motion of the closure mechanism 144 to be mechanically dependent on the motion of the compaction system 104. This may be advantageous because the closure mechanism 144 may be operable without a dedicated actuator or actuation system to open and close the chute 140. That is, independent control systems for the compaction system 104 and for the closure mechanism 144 might not be necessary. Rather, a single control mechanism for the compaction system 104 may be provided and any and all motion of the closure mechanism 144 may occur by way of mechanical interaction (e.g., mechanical following) with the compaction system 104.

In one or more examples, the operability of the closure mechanism 144 may relate to only a portion of the stroke of the compaction system 104. In particular, the operability of the closure mechanism 144 may relate to a beginning portion of the compaction cycle. That is, as the compaction system 104 begins its cycle, motion of the compaction system 104 may lower the carrying feature 166. Since the closure mechanism 144 is free to move under the forces of gravity and since the carrying feature 166 may be engaging the catch 168 to resist the forces of gravity, as the carrying feature 166 lowers, the first/second closure panels 146/148 may move through their full range of motion from an open position to a closed position. When the first/second closure panels 146/148 reach their closed position, the compaction system 104 may have travelled through only a portion of its compaction cycle. At this point, motion of the first/second closure panels 146/148 may be arrested through contact of the front/lower edge of the second closure panel 148 with the front chute panel 140C or other panel or stop at or near the front of the machine 100. Since motion of the catch 168 on the closure mechanism 144 is arrested, further motion of the carrying feature 166 may cause the carrying feature 166 to release from or disengage the catch 168. This may occur by merely moving further downward away from the catch 168 while the catch 168 maintains its position due to the arrested motion of the closure panels 144. The compaction system 104 may continue to extend until it reaches its fully extended position. The fully extended position may be determined by a physical distance or by a pressure or force sensor that may control how much compaction force is exerted by the compaction system 104.

Upon reaching its fully extended position and after performing any hold down operations, the compaction system 104 may begin to retract. At some point along its travel, the carrying feature 166 may reengage the catch 168 on the closure panels 146/148 by coming into contact with a bottom side of the catch 168. At this point, further retraction of the compaction system 104 may cause the closure panels 146/148 to follow the motion of the compaction system 104 and pass through their range of motion from a fully closed position to a fully open position. The location of the carrying feature 166 and the catch 168 may be selected such that when the compaction system 104 is in its fully retracted position, the closure panels 146/148 are in their fully or almost fully open position. That is, the closure panels 146/148 may stop just short of being fully open at the top of the compaction cycle to avoid putting undue pressure or force on the carrying feature, the catch, and/or the closure panels. It is worth noting that the motion of the compaction system may be generally parallel to the motion of the first closure panel 146 such that the carrying feature 166 and the catch 168 maintain contact throughout the range of motion of the first closure panel.

It is to be appreciated that while a full range of travel of the closure panels 146/148 may occur during only a partial range of travel of the compaction system 104, other approaches may be used where, for example, the motion of the closure panels 146/148 is tied to the motion of the compaction system 104 for all or most of its compaction cycle. However, the present approach may be advantageous by providing for closure of the closure panels 146/148 well ahead of any pressure development between the ram and the trash. This may help to ensure access within the enclosure is closed off before higher forces develop. Still further, and due to the varying stroke length of the compaction system 104 that may depend on the amount of trash in the receptacle, having the closure panels 146/148 close near the beginning of the compaction cycle may help to ensure that the closure panels 146/148 fully close even when the compaction cycle is shortened due to increasing amounts of trash.

The compaction machine 100 may also include an electronic control module 170 for controlling the compaction cycle of the machine 100, monitoring and controlling access to the machine 100 and otherwise monitoring operation of the machine 100. In one or more examples, the electronic control module 170 may control power to a magnet that may maintain the closure panels 146/148 in a close position. For example, in one or more examples, when the first/second closure panels 146/148 reach their closed position, a tab 172 extending forward from the flaps 156 may contact a magnet 174, which may be powered on by the electronic control module 170 to maintain the closure panels in a closed position. Upon retraction or return of the ram 124 of the compaction system 104, the magnet 174 may be powered off to allow the compaction system to lift the first closure panel 146 and the second closure panel 148 to open the chute 140. While a powered magnet has been described, a non-powered magnet may also be used where the magnet force is selected to hold the closure panels 146/148 closed, but a relatively small force such as from the compaction system pulling on the panels 146/148 may free them from the magnet.

Sensors may also be provided to ascertain the position of the first and/or second closure panel, for example. That is, for example, a proximity sensor or other sensor may be provided for confirming that the closure panels 146/148 have reached the closed position before allowing the compaction system to complete its compaction cycle. Where the closure panels 146/148 do not reach the fully closed position, the compaction system 104 may be cycled (i.e., returned to its retracted position and advanced) one, two, three, or other number of times to try to get the panels 146/148 to reach their closed position. After a selected number of cycles, the compaction system 104 may return to its retracted position and an error indicator may be activated such as a blinking LED or other indicator.

Still further, sensors may be provided to monitor the level of trash in the receptacle such that the electronic control module can trigger compaction cycles at the appropriate time, can perform hold down operations periodically, and can identify when the receptacle is full. When the receptacle is full, the compaction ram may be maintained in an advanced or expanded position to hold down the trash and the first/second closure panels 146/148 may be maintained in a closed position by the magnet or other holding or locking mechanism. Alternatively, when the receptacle is full, the compaction ram may be retracted, but may stop short of being fully retracted to avoid opening the closure panels 146/148. This may allow the trash bin to be accessed and removed because the ram may be retracted out of the bin, but may also maintain the closure panels 146/148 closed such that further trash is not placed in the machine. User intervention may be performed by way of using a key, code, key card, or other device or system to access the machine 100. When accessing the machine 100, the operator may remove the receptacle through an access door, dump the receptacle, and may return the receptacle within the machine 100. Closure and locking of the access panel may cause the electronic control module to resume operations. For example, where the compaction ram was not fully retracted, the ram may now be fully retracted, thus, opening the closure panels 146/148 such that the machine is ready to receive trash. Where the ram is maintained in a hold down position when the receptacle is full, user opening of the machine may cause partial or full retraction of the ram to allow the receptacle to be removed. If only partial retraction is performed when the operator opens the machine, operator closure and/or locking of the machine may trigger the ram to return to is fully retracted position.

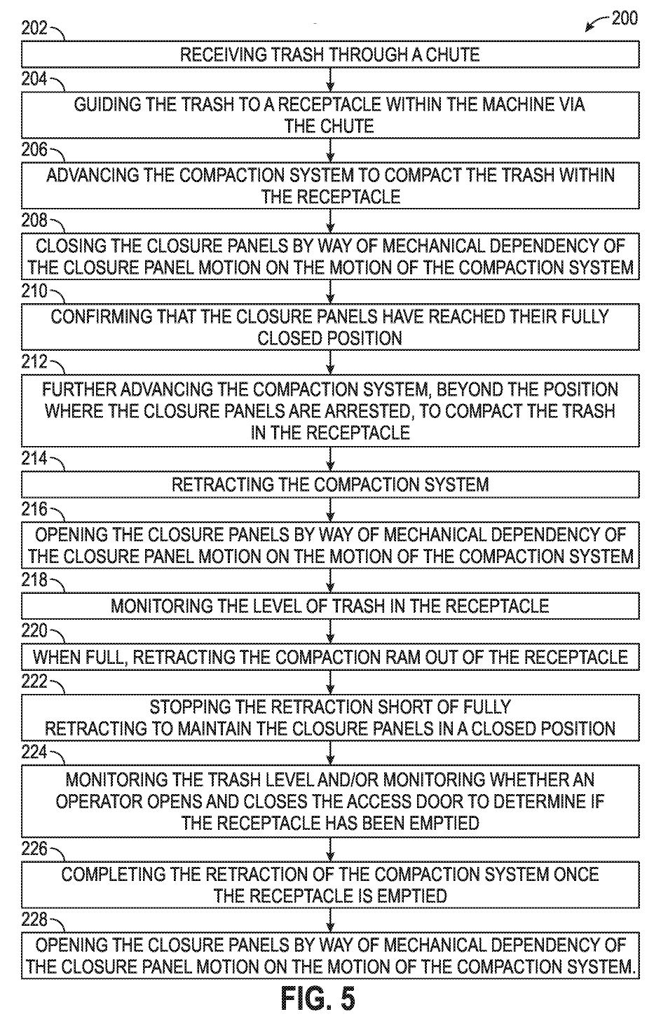

In one or more examples, and with reference to FIG. 5 a method 200 of operation may be performed by the machine. For example, mechanical components of the machine may be operable by a processor of the controller and operating instructions may be stored in a computer readable storage medium on or within the controller. The operating instructions may be in the form of hardware, software, or a combination of hardware and software. The instructions may be operable by the processor to perform particular functions. In one or more examples, the method 200 may include include receiving 202 trash through a chute and guiding 204 the trash to a receptacle within the machine via the chute. The method may also include periodically, based on trash volume and/or time intervals, advancing 206 the compaction system to compact the trash within the receptacle (e.g., driving a ram of the compaction system toward and into the receptacle). This step may include closing 208 the closure panels 146/148 by way of mechanical dependency of the closure panel motion on the motion of the compaction system. That is, the closure panels may close at a rate consistent and/or dependent on the rate of the ram motion and the closure panel motion may be based on gravity. The motion of the closure panels may be such that they reach their fully closed position prior to the compaction system developing compaction pressure. That is, the closure panels may move from an open position to a closed position during a first portion of the driving. The method may also include confirming 210 that the closure panels have reached their fully closed position. Where the closure panels have not reached their fully closed position, the compaction system may be cycled, thereby opening and closing the closure panels in an effort to fully close the panels. Where the closure panels have reached their fully closed position, the method may also include securing the closure panels with a magnet. The method may also include further advancing 212 the compaction system, beyond the position where the closure panels are arrested, to compact the trash in the receptacle. The method may also include retracting 214 the compaction system 104 after the compacting to its fully retracted position. This step may include opening 216 the closure panels by way of mechanical dependency of the closure panel motion on the motion of the compaction system. The method may also include monitoring 218 the level of trash in the receptacle. When the receptacle is compacted with the compaction system and is full, the compaction system may be retracted 220 out of the receptacle, but may stop 222 short of fully retracting to maintain the closure panels in a closed position. The method may also include monitoring 224 the trash level and/or monitoring whether an operator opens and closes the access door to determine if the receptacle has been emptied. The method may also include completing 226 the retraction of the compaction system once the receptacle is emptied where the closure panels are opened 228 based on the mechanical dependency of their motion to the motion of the compaction system.

As used herein, the terms “substantially” or “generally” refer to the complete or nearly complete extent or degree of an action, characteristic, property, state, structure, item, or result. For example, an object that is “substantially” or “generally” enclosed would mean that the object is either completely enclosed or nearly completely enclosed. The exact allowable degree of deviation from absolute completeness may in some cases depend on the specific context. However, generally speaking, the nearness of completion will be so as to have generally the same overall result as if absolute and total completion were obtained. The use of “substantially” or “generally” is equally applicable when used in a negative connotation to refer to the complete or near complete lack of an action, characteristic, property, state, structure, item, or result. For example, an element, combination, embodiment, or composition that is “substantially free of” or “generally free of” an element may still actually contain such element as long as there is generally no significant effect thereof.

To aid the Patent Office and any readers of any patent issued on this application in interpreting the claims appended hereto, applicants wish to note that they do not intend any of the appended claims or claim elements to invoke 35 U.S.C. § 112(f) unless the words “means for” or “step for” are explicitly used in the particular claim.

Additionally, as used herein, the phrase “at least one of [X] and [Y],” where X and Y are different components that may be included in an embodiment of the present disclosure, means that the embodiment could include component X without component Y, the embodiment could include the component Y without component X, or the embodiment could include both components X and Y. Similarly, when used with respect to three or more components, such as “at least one of [X], [Y], and [Z],” the phrase means that the embodiment could include any one of the three or more components, any combination or sub-combination of any of the components, or all of the components.

In the foregoing description various embodiments of the present disclosure have been presented for the purpose of illustration and description. They are not intended to be exhaustive or to limit the invention to the precise form disclosed. Obvious modifications or variations are possible in light of the above teachings. The various embodiments were chosen and described to provide the best illustration of the principals of the disclosure and their practical application, and to enable one of ordinary skill in the art to utilize the various embodiments with various modifications as are suited to the particular use contemplated. All such modifications and variations are within the scope of the present disclosure as determined by the appended claims when interpreted in accordance with the breadth they are fairly, legally, and equitably entitled.

What is claimed is:

1. A compaction machine, comprising:
an enclosure defining an opening for receiving trash;
a compaction system having an actuation portion and a ram, the compaction system being arranged within the enclosure and configured for compacting the trash within the enclosure by performing a compaction cycle including moving the ram from a retracted position to an expanded position; and
a closure mechanism operable between an open position where the opening is generally unobstructed and a closed position where the closure mechanism closes off the opening,
wherein the operability of the closure mechanism between the open position and the closed position is mechanically dependent on motion of the compaction system over at least a portion of the compaction cycle.

2. The compaction machine of claim 1, wherein the opening in the enclosure gives way to a chute extending into the compaction machine.

3. The compaction machine of claim 2, wherein the chute comprises and open bottom and wherein the closure mechanism closes off the opening by closing off the open bottom of the chute.

4. The compaction machine of claim 1, wherein the closure mechanism comprises a first closure panel and a second closure panel.

5. The compaction machine of claim 4, wherein the first closure panel is arranged in and articulates in a generally vertical plane.

6. The compaction machine of claim 5, wherein the second closure pivotally depends from a bottom edge of the first closure panel.

7. The compaction machine of claim 6, wherein the second closure panel comprises a rear edge and a front/lower edge and the rear edge is pivotally coupled to the bottom edge of the first closure panel.

8. The compaction machine of claim 7, wherein the front/lower edge is pivotable about a translating axis.

9. The compaction machine of claim 1, wherein the closure mechanism is operable during a first portion of the compaction cycle.

10. The compaction machine of claim 4, wherein the chute comprises a back chute panel arranged at or near a mid-depth of the compaction system.

11. The compaction machine of claim 10, wherein the back chute panel extends partially along the height of the chute.

12. The compaction machine of claim 11, wherein the vertical plane is adjacent the back chute panel and the first closure panel cooperates with the back chute panel to close off the chute when the closure mechanism is in the closed position.

13. The compaction machine of claim 1, wherein the compaction system comprises a carrying feature and the closure mechanism comprises a catch for engagement by the carrying feature.

14. The compaction machine of claim 13, wherein the carrying feature comprises a ledge and the catch comprises an overhang that overlaps with the carrying feature when viewed from above.

15. The compaction machine of claim 14, wherein the mechanical dependency is provided by engagement of the carrying feature with the catch.

16. The compaction machine of claim 1, wherein motion of the closure mechanism is driven by gravity and the mechanical dependency occurs by way of the compaction system allowing the closure mechanism to close under a force of gravity.

17. The compaction machine of claim 1, wherein after the compaction system has performed the at least a portion of the compaction cycle, the closure mechanism motion is arrested while the compaction system continues to the expanded position.

18. The compaction machine of claim 17, wherein the expanded position is defined by a stroke length or a maximum force.

19. A method of opening and closing a compaction machine, the method comprising:
activating a compaction system within an enclosure and driving a ram toward and into a receptable holding trash to compact the trash; and
allowing a closure mechanism to close off an opening in the enclosure under the force of gravity at a rate controlled by motion of a portion of the compaction system during the driving.

20. The method of claim 19, wherein the closure mechanism moves from an open position to a closed position during a first portion of the driving.
